(19) United States
(12) Patent Application Publication
(10) Pub. No.: US 2008/0212533 A1
(43) Pub. Date: Sep. 4, 2008

(54) Method For the Reconfiguration of an Information Processing Unit of a Terminal

(75) Inventors: Benoît Miscopein, Grenoble (FR); Eric Batut, Saint Martin-Gimois (FR); Jean Schwoerer, Grenoble (FR); Patrice Senn, Grenoble (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 11/919,582

(22) PCT Filed: Apr. 24, 2006
(86) PCT No.: PCT/FR2006/000916

§ 371 Date: Dec. 18, 2007

(30) Foreign Application Priority Data
May 3, 2005 (FR) 0504500

(51) Int. Cl. H04Q 7/00

(52) U.S. Cl. 370/331

(57) ABSTRACT

The invention relates to a method for the reconfiguration of an information processing unit of a terminal (1), said terminal being/arranged in such a way as to receive information from a communication system (2, 3). The inventive method comprises the following steps: a reconfiguration phase of the information processing unit is initiated; and an information message signalling the initiation of the reconfiguration phase of the information processing unit is transmitted from the terminal to the communication system.

The present invention relates to the reconfiguration of an information processing unit of a terminal.

A terminal normally comprises at least one information processing unit. This unit performs a certain number of operations on information that it receives from a communication system, or that it transmits to such a system. From the first, it should be noted that the word “communication” is used here in the broad sense of the term. It can in particular be a point-to-point communication or a point-to-multipoint broadcast. The abovementioned operations can include, for example, a modulation/demodulation, an analogue/digital or digital/analogue conversion and a coding/decoding operation.

The information processing unit of a terminal may need to perform a reconfiguration, so as to modify the processing that it applies to the incoming or outgoing information.

Such a reconfiguration may be necessary in particular to change communication mode. As an example, in the radiocommunications field, a dual-mode terminal may be capable of communicating with equipment corresponding to a communication system using a GSM (Global System for Mobile communication) technology on the one hand and a UMTS (Universal Mobile Telecommunication System) technology on the other hand. This can in particular occur when the radio coverage of the communication system is not uniform and when localized islands of UMTS coverage are scattered in a set with GSM coverage.

When the terminal roams from the set with GSM coverage to a localized island of UMTS coverage, its information processing unit can perform a reconfiguration phase in order to switch from processing information exchanged with the communication system according to the GSM technology to processing according to the UMTS technology.

Another example could be a radio terminal able to communicate selectively according to a frequency division duplex (FDD) mechanism or a time division duplex (TDD) mechanism.

Yet another example can concern a change of coding on the part of the information processing unit of a terminal, without in any way changing the communication standard.

During a reconfiguration phase, the processing of the information received by the terminal can be degraded or even interrupted. This state has a negative effect on the quality of service. In particular, when the information is received by the terminal in the context of a communication, the latter is likely to undergo a major degradation or even be cut off.

The present invention aims to allow an improvement in the quality of service in the event of reconfiguration within a terminal.

The invention thus proposes a method of reconfiguring an information processing unit of a terminal, said terminal being arranged to receive information from a communication system. The method comprises the following steps:
initiating a phase for reconfiguration of the information processing unit; and
sending, from the terminal to the communication system, information signaling the initiation of the phase for reconfiguration of the information processing unit.

The sending, to the communication system, of the information signaling the initiation of the phase for reconfiguration of the information processing unit, makes it possible to make this system aware of the initiation of the reconfiguration. The communication system can then, if necessary, take account of this information to adapt its operation accordingly. The system is thus given the means of acting to maintain the quality of service, despite the existence of the reconfiguration.

Advantageously, the terminal can also signal an event following the end of the phase for reconfiguration of its information processing unit. This information can again be used by the communication system to adapt its operating mode. For example, a nominal processing of the information transmitted by this system can be repeated on notification of said event.

During the reconfiguration phase, it is possible advantageously to store, in a buffer memory of the terminal, information received from the communication system. This makes it possible to retain information that can be processed by the information processing unit of the terminal after the reconfiguration phase. The information transmitted by the system during the reconfiguration could otherwise be lost.

Advantageously, a degraded processing is implemented by the information processing unit after the reconfiguration phase, so as to empty the buffer memory of the terminal at an accelerated rate. Thus, the quality of service is improved by limiting the delay in the processing of the information received.

The invention also proposes a method of communication between a terminal comprising an information processing unit and a communication unit able to transmit information to said terminal. The method comprises the following step, when the communication system transmits information to said terminal in the context of a communication:
sending, from the terminal to the communication system, information signaling the initiation of a phase for reconfiguration of the information processing unit of the terminal.

By signaling the initiation of a reconfiguration phase, the communication system has available relevant information that it can, if necessary, subsequently make use of. In particular, this system can adapt its mode of transmission of information to the terminal, so as to maintain an acceptable quality of service for the current communication.

As an example, the communication system can, once alerted to the initiation of the reconfiguration, introduce a delay in the transmission of certain information intended for the terminal, increase the protection of certain information intended for the terminal against errors or even increase the compression of certain information intended for the terminal.

The invention also proposes a terminal comprising an information processing unit and arranged to receive information from a communication system. The terminal comprises:
means for initiating a phase for reconfiguration of the information processing unit; and
means for informing the communication system of the initiation of the phase for reconfiguration of the information processing unit.

The invention also proposes a communication system arranged to transmit information to at least one terminal comprising an information processing unit. The communication system comprises:
means for receiving from the terminal information signaling the initiation of a phase for reconfiguration of the information processing unit of the terminal.

The invention also proposes a computer program product comprising instructions able to implement a reconfiguration of an information processing unit of a terminal arranged to receive information from a communication system, according to the following steps, when said program is loaded and run by computer means of the terminal:
initiating a phase for reconfiguration of the information processing unit; and
sending, from the terminal to the communication system, information signaling the initiation of the phase for reconfiguration of the information processing unit.

The invention finally proposes a computer program product comprising instructions able to implement the following step, when said computer program is loaded and run by computer means of a communication system arranged to transmit information to at least one terminal comprising an information processing unit:
receiving from the terminal information signaling the initiation of a phase for reconfiguration of the information processing unit.

Other features and advantages of the present invention will become apparent from the description below of non-exclusive exemplary embodiments, with reference to the appended drawings in which:

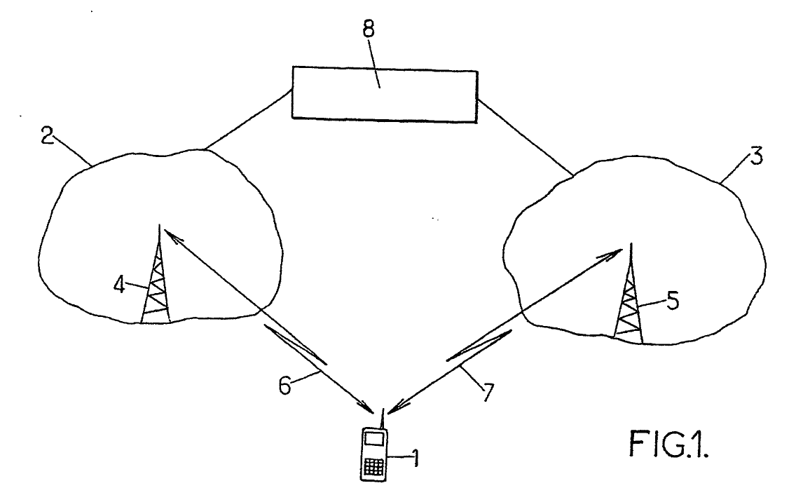

FIG. 1 is a functional architecture diagram of a system in which the invention can be implemented;

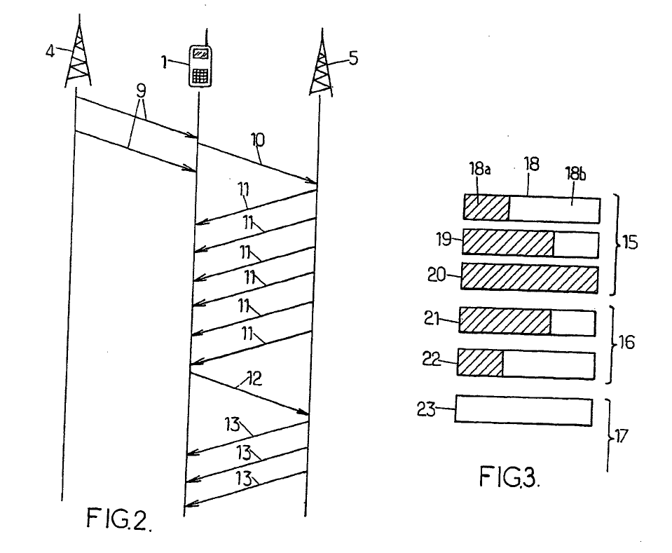

FIG. 2 is a diagram showing information exchanges within the system of FIG. 1 according to one embodiment of the invention;

FIG. 3 is a diagram showing the state of a buffer memory of a terminal, correlated with the information exchange of FIG. 2.

FIG. 1 shows a communication (or broadcast) system comprising two subsystems 2 and 3, each able to communicate according to a communication mode. In the example described below, the subsystem 2 is a GSM network whereas the subsystem 3 is a UMTS network. An interconnection can be provided between these two subsystems, for example via a supervision manager 8, so as to ensure continuity of service between them.

It will be noted that the subsystems 2 and 3 could use any other communication standard. For example, they could both implement the GSM or UMTS technology, in FDD mode regarding subsystem 2 and in TDD mode regarding the subsystem 3. They could also implement one and the same communication standard, but differ only by the coding applied.

It will also be noted that the two subsystems 2 and 3 have been represented separately in FIG. 1. However, it is also possible for the communication system to comprise a single set of equipment able to apply several communication modes selectively.

A terminal 1 is able to communicate selectively according to each of the communication modes implemented by the communication system. In the example described with reference to FIG. 1, the terminal 1 is therefore a dual-mode radio terminal able to communicate according to the GSM technology and according to the UMTS technology.

The terminal 1 can thus receive information from the network 2 according to the GSM protocol, via the base station 4. It can also receive information from the network 3 according to the UMTS protocol, via the base station 5.

It will be noted that, when the communication system with which the terminal 1 exchanges information cannot be divided into separate subsystems, one and the same base station can allow the communication with the terminal 1 according to one or other of the GSM and UMTS technologies.

In the example described below, the terminal 1 comprises a single information processing unit that can be reconfigured to process the information exchanged with one or other of the networks 2 and 3.

Thus, if the terminal 1 is initially communicating in GSM mode with the network 2 and if the communication must be continued in UMTS mode, at the initiative of the terminal or of the communication system, the terminal 1 then reconfigures its information processing unit so that it can process information in UMTS mode. The network 2 indicates to the network 3, for example via the supervision manager 8, that it must continue the communication. The latter is then resumed between the terminal 1 and the network 3, according to the UMTS technology, after reconfiguration of the information processing unit of the terminal 1.

During its reconfiguration, the information processing unit of the terminal 1 is unable to process the information still being received from the network 2 and the information already received from the network 3. To this end, the terminal 1 can advantageously store, in a buffer memory, the information received during this period, in order to process it once its information processing unit is reconfigured and therefore once again operational.

This mode of operation is illustrated in the top part of FIGS. 2 and 3. Initially, the base station 4 of the network 2 transmits information frames 9 to the terminal 1 according to the GSM protocol, in the context of a communication. Then, the terminal 1 initiates a phase for reconfiguration of its information processing unit, to switch from the GSM mode to the UMTS mode. At the same time, the base station 5 of the network 3 begins to transmit information frames 11 relating to the current communication, according to the UMTS technology. The terminal 1 then fills its buffer memory, if it has one, with the frames received during the reconfiguration phase.

This buffer memory can be dedicated to this use or even be the same as that used to temporarily place all the information received, pending processing by the information processing unit of the terminal 1. In order to simplify the explanation, hereinafter there is assumed to be a buffer memory dedicated to temporarily receiving the information received during the reconfiguration phase.

Thus, the first frames 11 received from the base station 5 are placed in the area 18a of the buffer memory 18, thus leaving an empty area 18b in this memory. As the frames 11 are received on the terminal 1, the terminal places them in its buffer memory (reference 19 in FIG. 3), until the buffer memory is entirely filled (reference 20 in FIG. 3) or even until the reconfiguration within the terminal 1 is completed. Preferably, the buffer memory of the terminal 1 is dimensioned so that it can contain all the information received during a reconfiguration phase.

The reconfiguration phase (reference 15 in FIG. 3) is therefore accompanied, as appropriate, with the filling of the buffer memory of the terminal with information received on the terminal 1 and pending processing. This advantageous mode of operation avoids the loss of the frames received by the terminal during the reconfiguration phase.

According to the invention, the network 3 is informed of the initiation of the reconfiguration phase within the terminal 1. The terminal 1 can thus signal to the network 3, via the base station 5, that the reconfiguration phase has started (message 10 in FIG. 2). This information is, for example, transmitted over a dedicated physical channel or a common control channel.

In this case, the initiation of the reconfiguration phase can be almost simultaneous with the transmission of the message 10, or even trigger the transmission of this message 10.

As a variant, the message 10 can be sent by the terminal 1 before the initiation of the reconfiguration phase. In this case, it advantageously contains an indication of the moment when the reconfiguration will start. The network 3 can thus anticipate any measures to be taken to take account of the reconfiguration phase to come.

On receiving this message, the network 3 can adapt its operating mode so as to take account of the fact that the reconfiguration phase has started or will start.

The operating mode implemented aims, for example, to limit the occupancy of the buffer memory of the terminal 1, in order for the latter to be able to rapidly process the information temporarily stored in this memory. When the terminal 1 has no buffer memory, the network can nevertheless react to the information on the initiation of the reconfiguration phase, for example by temporarily interrupting its transmissions for the attention of the terminal 1.

It should be noted, however, that the network 3 is free to interpret the information on the initiation of the reconfiguration phase within the terminal 1 as it wishes. It can even disregard this information and continue to operate in the same mode. Thus, the sending of the message 10 by the terminal 1 makes it possible above all to provide the network 3 with relevant information that the network can make use of as it wishes, in order to maintain a satisfactory quality of service for the current communication.

In a first embodiment, the network 3 can react to the reception of the information on the initiation of the reconfiguration phase by deferring the sending of frames from the base station 5 to the terminal 1. The frames 11 can thus be sent after a predetermined delay, running for example from the reception of the message 10 by the network 3, so as to avoid a loss of information or even, as appropriate, overfilling of the buffer memory of the terminal 1. In the latter case, any saturation of the buffer memory which would result in a loss of information transmitted by the base station 5 is thus avoided.

It will be noted that the delay introduced in the transmission of certain frames sent by the base station 5 can be envisaged only in the case where the communication mode implemented by the network 3 supports it and where such a delay is acceptable for the current communication (data transmission with no real time constraint for example).

In a second exemplary embodiment, the network 3 can react to the reception of the information on the initiation of the reconfiguration phase by compressing the information to be transmitted by the base station 5 with a compression level greater than on the other information. Thus, the quantity of frames sent from the base station 5 to the terminal 1 is limited and, where appropriate, saturation of the buffer memory of the terminal and therefore the loss of information is avoided. Of course, the terminal 1 must have corresponding decompression algorithms to retrieve the information transmitted by the base station 5. Any known compression/decompression algorithm can be used for this purpose.

In another advantageous embodiment, provision is also made for the processing performed by the information processing unit of the terminal 1 to be degraded after the initiation of the reconfiguration phase, so as to empty the buffer memory at an accelerated rate. In other words, some of the algorithms implemented by the information processing unit of the terminal 1 are less powerful but more rapid than in the nominal case, after the initiation of the reconfiguration phase (phase 16 in FIG. 3).

In this case in particular, it may be advantageous for the network 3 to react to the reception of the information on the initiation of the reconfiguration phase by protecting the information transmitted by the base station 5 against errors with a protection level greater than on the other information. For example, the frames 11 transmitted by the base station 5 can include more information redundancy than the frames transmitted in nominal mode. In this way, even if the terminal 1 implements degraded processing algorithms, it can retrieve, without excessive errors, the information transmitted.

It will also be noted that a limitation of the information frames transmitted by the base station 5 to the terminal 1, when the network 3 has been informed of the initiation of the reconfiguration phase, is also advantageous when the information processing unit of the terminal 1 implements degraded processing algorithms. In practice, as has been explained above, a transmission delay or an increased compression of the information by the network 3 limits the occupancy of the buffer memory of the terminal 1 and therefore the quantity of information that must be processed with the degraded algorithms. Thus, the processing quality is enhanced on the terminal, by prioritizing the nominal processing of the information, and the quality of the communication is consequently maintained.

Of course, other operations can be implemented by the network 3 on reception of the information on the initiation of the reconfiguration phase within the terminal 1, so as to take account of this situation. As an example, a combination of the exemplary embodiments described above can be envisaged. Thus, the information transmitted by the base station 5 can be both compressed and redundant. In this way, the compression limits the increased amount of information to be transmitted because of the redundancy. It is thus possible to transmit the same quantity of information as in the nominal mode while preserving the quality of the communication possibly affected by the temporary implementation of degraded processing operations by the terminal 1.

As has been described above, the network 3 can react to the reception of the information according to which a communication reconfiguration phase has been initiated on the terminal 1, by processing certain information, before it is transmitted to the terminal 1, in a particular way (transmission delay, increased compression, increased protection against errors, etc.).

This particular processing can be applied immediately the network 3 is informed of the initiation of the reconfiguration phase (message 10 in FIG. 2). It can be applied to a predetermined number of frames 11. For example, all the frames 11 transmitted to the terminal 1, between the reception of the message 10, starting up a time counter, and the expiry of this counter, can be processed in a particular way. The counter will then advantageously be set to cover the average duration of a reconfiguration phase.

As a variant, the message 10 can contain an indication enabling the network 3 to deduce the time needed to reconfigure the information processing unit of the terminal 1. This indication can be of the temporal type, for example a reconfiguration duration. It can also designate a type of reconfiguration (e.g. change of communication standard, change of coding/decoding, etc.).

In another embodiment, the particular processing of the information transmitted by the base station 5 to the terminal 1 can be applied until the network 3 is notified of an event following the initiation of the reconfiguration phase.

The event concerned can, for example, be the end of the reconfiguration phase, namely the moment when the information processing unit of the terminal is configured to communicate with the network 3 according to the UMTS technology. At the end of the reconfiguration phase, in practice, the information processing unit of the terminal 1 is again able to process the information received or, where appropriate, stored in its buffer memory provided that this buffer memory can begin to be emptied (phase 16 and states 21 and 22 in FIG. 3).

As a variant, when the terminal 1 has a buffer memory, the event concerned can designate the moment when the occupancy rate of this buffer memory falls below a predetermined threshold. When the buffer memory concerned is dedicated to the temporary reception of the information received following the initiation of the reconfiguration phase, the threshold can, for example, be set to zero. In this case, the terminal 1 sends a message 12 to the base station 5 to indicate to it that its buffer memory is empty and that the nominal processing of the information transmitted by the base station 5 can be resumed. The network 3 thus resumes nominal operation only when it is notified that the terminal 1 can again process the received information satisfactorily.

Similarly, if the terminal 1 implements a degraded processing of the received information after the initiation of the reconfiguration phase, it can resume its nominal operation when the event concerned occurs. It is thus possible to ensure consistent operation of the terminal 1 and of the network 3.

Subsequently, the information transmitted in the frames 13 can be processed by the base station 5 and the network 3 nominally, that is, with the usual compression and protection algorithms and without delay (phase 17 in FIG. 3). The buffer memory of the terminal 1 remains empty or with little occupancy (state 23 in FIG. 3).

In light of the above, it will be understood that the invention makes it possible to optimize the radio resources by taking account of the time needed for the reconfiguration phase within the terminal.

It will be noted that, in the example described above, the terminal 1 had a single information processing unit. However, the invention is also applicable to a terminal comprising several independent information processing units, each capable of processing information according to respective processing operations. In this case, the reconfiguration phase must be interpreted as a switchover from one information processing unit to another.

Such a switchover is not in fact instantaneous. During the switchover period, the processing of the information received by the terminal is degraded, even interrupted, as in the case of a reconfiguration of a single information processing unit. The operations described above therefore remain applicable in this case and make it possible to obtain the same type of improvement.

The operations described above can also be implemented using appropriate computer programs. For example, a program loaded and run on the terminal can contain instructions for performing a reconfiguration procedure, namely initiating a reconfiguration phase and informing the network of this. Another program loaded and run by computer means of the network can contain instructions for receiving the information on the initiation of a reconfiguration phase within the terminal and, where appropriate, accordingly adapt the processing of the information transmitted to the terminal.

1. A method of reconfiguring an information processing unit of a terminal, said terminal being arranged to receive information from a communication system, the method comprising:
initiating a phase for reconfiguration of the information processing unit; and
sending, from the terminal to the communication system, information signaling the initiation of the phase for reconfiguration of the information processing unit.

2. The reconfiguration method as claimed in claim 1, further comprising transmitting, from the terminal to the communication system, information signaling an event following an end of the phase for reconfiguration of the information processing unit.

3. The reconfiguration method as claimed in claim 1, further comprising storing, in a buffer memory of the terminal, the information received from the communication system, during the phase for reconfiguration of the information processing unit.

4. The reconfiguration method as claimed in one of claims 2 and 3, in which the event following the end of the phase for reconfiguration of the information processing unit comprises a transition below a predetermined threshold of an occupancy ratio of the buffer memory of the terminal.

5. The reconfiguration method as claimed in claim 3, further comprising applying a degraded processing operation by the information processing unit after the phase for reconfiguration of said information processing unit, so as to empty the buffer memory of the terminal at an accelerated rate.

6. A method of communication between a terminal having an information processing unit, and a communication unit able to transmit information to said terminal, the method comprising:
sending, from the terminal to the communication system, information signaling the initiation of a phase for reconfiguration of the information processing unit of the terminal, wherein the sending occurs when the communication system transmits information to said terminal in the context of a communication.

7. The communication method as claimed in claim 6, in which the reconfiguration of the information processing unit of the terminal comprises a change of communication mode from a first communication mode to a second communication mode.

8. The communication method as claimed in claim 6, further comprising, following the sending of information signaling the initiation of the phase for reconfiguration of said information processing unit, transmitting information from the communication system to the terminal, at least some of said information being processed, before transmission, to take account of the initiation of the phase for reconfiguration of said information processing unit.

9. The communication method as claimed in claim 8, further comprising sending, from the terminal to the communication system information signaling an event following the end of the phase for reconfiguration of the information processing unit.

10. The communication method as claimed in claims 8 or 9, in which the information processed before transmission to take account of the initiation of a phase for reconfiguration of said information processing unit, comprises at least some of the information transmitted from the communication system to the terminal between receptions, by the communication system, of information signaling the initiation of a phase for reconfiguration of the information processing unit and of information signaling an event following the end of the phase for reconfiguration of the information processing unit.

11. The communication method as claimed in claim 8, in which the processing before transmission of at least some of the information transmitted from the communication system to the terminal, to take account of the initiation of a phase for reconfiguration of said information processing unit, comprises information consisting of at least one of the introduction of a transmission delay, increased protection against errors and an increased compression.

12. A terminal having an information processing unit and arranged to receive information from a communication system, the terminal comprising:
means for initiating a phase for reconfiguration of the information processing unit; and
means for informing the communication system of the initiation of the phase for reconfiguration of the information processing unit.

13. A communication system arranged to transmit information to at least one terminal having an information processing unit, the communication system comprising:
means for receiving from the terminal information signaling the initiation of a phase for reconfiguration of the information processing unit of the terminal; and
means for processing, before transmission at least some of the information transmitted to the terminal, following the reception of the information signaling the initiation of the phase for reconfiguration of said information processing unit, to take account of said initiation.

14. (canceled)

15. A computer program product having instructions to implement a reconfiguration of an information processing unit of a terminal arranged to receive information from a communication system, according to the following steps, the program comprising:
initiating a phase for reconfiguration of the information processing unit; and
sending, from the terminal to the communication system, information signaling the initiation of the phase for reconfiguration of the information processing unit.

16. A computer program product for a communication system, comprising instructions for, when said computer program is loaded and run by computer means of a communication system arranged to transmit information to at least one terminal
receiving from the terminal information signaling the initiation of a phase for reconfiguration of the information processing unit.
